(19) United States
(12) Patent Application Publication
(10) Pub. No.: US 2014/0319782 A1
(43) Pub. Date: Oct. 30, 2014

(54) SEALING SYSTEM

(71) Applicant: Caterpillar Inc., Peoria, IL (US)

(72) Inventor: Khaled M. Mohammad, Tremont, IL (US)

(21) Appl. No.: 14/325,553

(22) Filed: Jul. 8, 2014

(51) Int. Cl. F16J 15/02

(52) U.S. Cl. CPC F16J 15/02
USPC 277/637

(57) ABSTRACT

A sealing system for an interface between two components is disclosed. The sealing system includes a plurality of sealing members provided adjacent to each other. At least two adjacent sealing members of the plurality of sealing members are coupled to one another by a joint. The joint includes a male portion disposed at an end of one sealing member and a female portion disposed at an end of another sealing member. The male portion extends by a first distance along a first longitudinal direction to a male end. Further, the female portion defines a pocket extending by a second distance along a second longitudinal direction to a female end and configured for receiving the male portion. The second distance of the pocket is greater than the first distance thereby forming a volume therebetween, the volume is configured to receive a sealant therein.

### TECHNICAL FIELD

The present disclosure relates to a sealing system, and more particularly a sealing system for an interface between two components.

### BACKGROUND

Machines typically include various types of assemblies which may include two mating components that require a sealing interface therebetween. The sealing interface may serve various purposes, for example, the sealing interface may prevent leakage of fluid from a joint of the two mating components. The two mating components may include, for example, an oil pan and an engine housing of an engine respectively.

Gaskets may be used within the joint in order to seal the sealing interface between the two mating components. In some examples, multiple segments of the gasket may be joined together to form the gasket. Generally, a sealant is provided between adjacent segments of the gasket for the sealing. In order to provide a good seal, an optimum amount of the sealant may need to be provided. However, it may be difficult to control the amount of the sealant being dispensed and introduced for the sealing of the gasket. The amount of the sealant dispensed between the adjacent segments of the gasket may be subject to variation based on personnel responsible for assembly of the gasket and hence may not be standardized. A low amount of the sealant may lead to an improper sealing of the adjacent segments of the gasket. At the same time, it is also not desirable to provide more than the optimum amount of the sealant, as this may lead to a wastage of the sealant.

U.S. Application Publication Number 2005/067787 describes a thin walled crushable capsule filled with curable sealant is disposed over a pocket formed between adjacent gaskets sealing between structural members. Upon assembly of the structural members the capsule is crushed and sealant flows into the pocket as the gaskets are compressed.

### SUMMARY OF THE DISCLOSURE

In one aspect of the present disclosure, a sealing system for an interface between two components is disclosed. The sealing system includes a plurality of sealing members provided adjacent to each other. At least two adjacent sealing members of the plurality of sealing members are coupled to one another by a joint. The joint includes a male portion disposed at an end of one sealing member of the two adjacent sealing members. The male portion extends by a first distance along a first longitudinal direction to a male end. The joint also includes a female portion disposed at an end of another sealing member of the two adjacent sealing members. The female portion defines a pocket extending by a second distance along a second longitudinal direction to a female end and configured for receiving the male portion therein. Further, the second distance of the pocket is greater than the first distance thereby forming a volume between the male end and the female end. Also, an opening of the female portion has a width less than a maximum width of the male portion in order to prevent disengagement of the male portion from the female portion along the first longitudinal direction or the second longitudinal direction. Further, the volume defined between the male portion and the female portion is configured to receive a sealant therein.

Other features and aspects of this disclosure will be apparent from the following description and the accompanying drawings.

### BRIEF DESCRIPTION OF THE DRAWINGS

FIG. 1 is a perspective view of an exemplary component having a sealing system, according to one embodiment of the present disclosure;

FIG. 2 is a cross sectional view of an exemplary bolted connection and the sealing system provided between two adjacent exemplary components that are similar in structure, one of the two exemplary components is of FIG. 1; and

FIGS. 3 and 4 are top views of a portion of the sealing system.

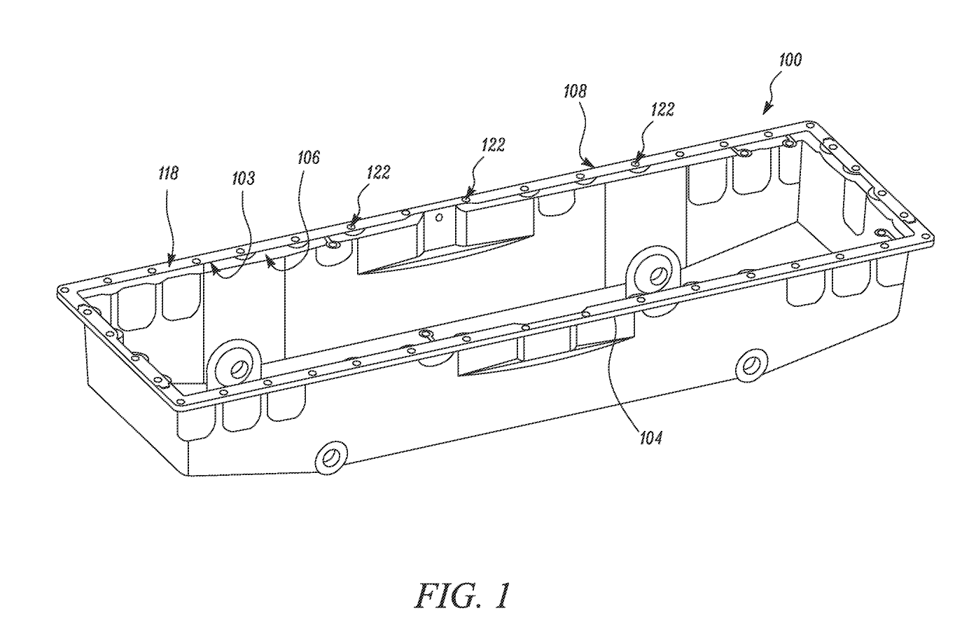

### DETAILED DESCRIPTION

Wherever possible, the same reference numbers will be used throughout the drawings to refer to the same or the like parts. FIG. 1 is a perspective view of an exemplary component 100. The component 100 may embody any component used in a machine associated with various industries, such as, construction, mining, automotive, power generation, and the like. In the illustrated embodiment, the component 100 is an oil pan 100 associated with an engine (not shown).

The engine, associated with the oil pan 100, may be an internal combustion engine such as, for example, a reciprocating piston engine. The engine may be a spark ignition engine or a compression ignition engine. The engine may be fueled by gasoline, diesel, biodiesel, dimethyl ether, alcohol, natural gas, propane, hydrogen, combinations thereof, or any other combustion fuel known in the art.

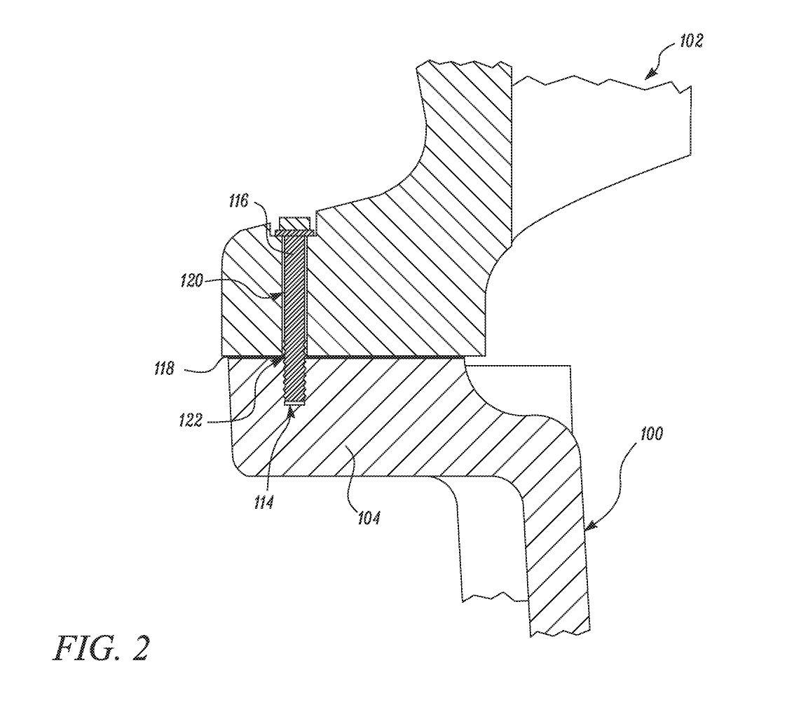

A cylinder block 102 (see FIG. 2) of the engine has a plurality of cylinders (not shown). Each of the plurality of the cylinders may be configured for housing a piston (not shown). Further, the cylinder block 102 of the engine may include a number of passages that allows working fluids, such as, engine coolant and/or oil to flow therethrough. The engine coolant is used for cooling the engine components, whereas the oil may be used for lubrication and/or actuation of various engine components, some of which are disclosed above. The oil is generally collected in the oil pan 100 when the engine is not operating, and may be pumped therefrom to flow through the engine components, by an oil pump (not shown). In one embodiment, the oil pan 100 may be mounted to an underside of the cylinder block 102 of the engine, so that the oil dripping from various engine components may get collect in the oil pan 100.

The oil pan 100 disclosed herein has a substantially rectangular shape. Further, the oil pan 100 may be made of a metal or a polymer. In one example, the oil pan 100 may be made of steel, such as, mild steel. Further, the oil pan 100 may be manufactured using a casting process, although other methods of forming may also be used, if desired. In the illustrated embodiment, the oil pan 100 is embodied as a top open and downwardly closed container. Referring to FIG. 1, the oil pan 100 may include a flange 104. The flange 104 may extend in an outward direction from an upper periphery 103 of the oil pan 100. The flange 104 has inner and outer surfaces 106, 108. The inner and outer surfaces 106, 108 may be co-planar. One of ordinary skill in the art will appreciate that the design of the oil pan 100 disclosed herein is exemplary and does not limit the scope of the present disclosure.

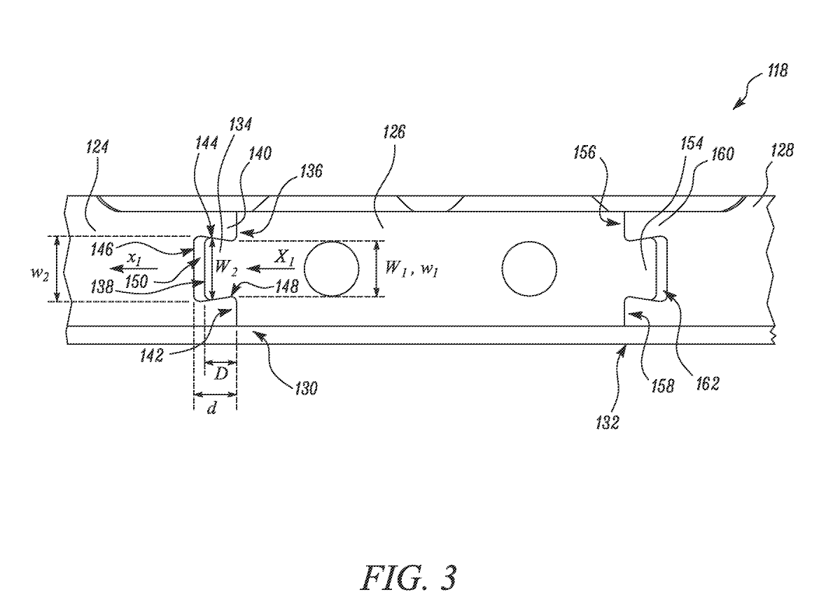

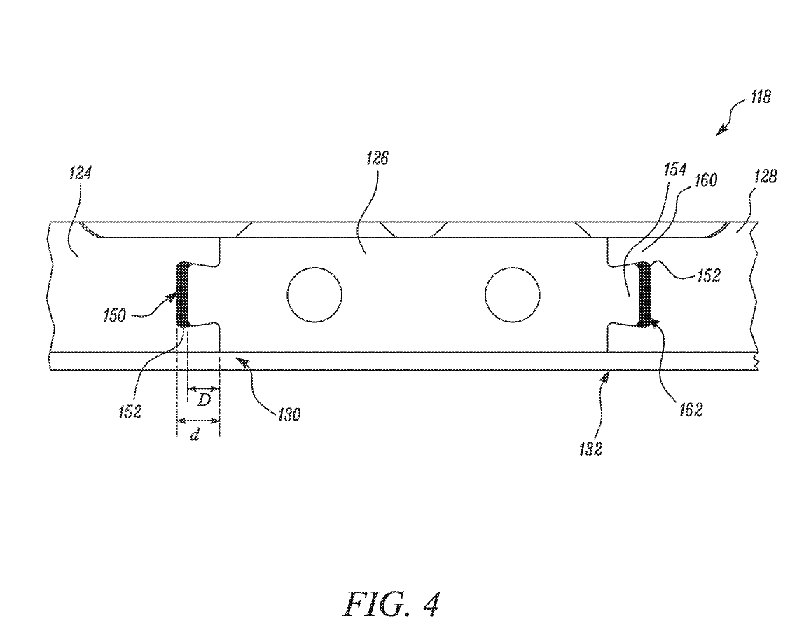

A sealing system 118 may be provided atop the flange 104. In one example, the sealing system 118 may be embodied as a multi-piece gasket. As shown in FIG. 2, when the cylinder block 102 is assembled with the oil pan 100, the sealing system 118 may be held between the oil pan 100 and the cylinder block 102. Further, the flange 104 may include a plurality of apertures 114. The cylinder block 102 and the sealing system 118 may also include a plurality of apertures 120, 122 respectively that correspond to the apertures 114 of the flange 104. The apertures 114 on the flange 104 and the apertures 120, 122 on the cylinder block and sealing system 102, 118 respectively are configured to receive fasteners 116 therethrough. The fasteners 116 may be any of a bolt, stud, rivet, screw, pin, and any other mechanical fastening means known in the art. The fasteners 116 are configured to connect the cylinder block 102, the sealing system 118, and the oil pan 100. The sealing system 118 of the present disclosure will now be explained in detail in relation to FIGS. 3 and 4.

The sealing system 118 may include a plurality of sealing members. Each of the plurality of sealing members is provided adjacent to each other. Further, the adjacent sealing members of the plurality of sealing members are coupled to one another by a joint. FIG. 3 is a top view of a portion of the sealing system 118. For the purpose of simplicity and clarity, three exemplary sealing members, viz. a first sealing member 124, a second sealing member 126, and a third sealing member 128 are shown in the accompanying figures. The first sealing member 124 is coupled to the second sealing member 126 by a first joint 130. Further, the second sealing member 126 is connected to the third sealing member 128 by a second joint 132. A plurality of such joints may be provided along a periphery of the sealing system 118 in order to couple the adjacent sealing members of the sealing system 118.

The first joint 130 which couples the first and second sealing members 124, 126 will now be explained in detail. The first joint 130 includes a male portion 134. The male portion 134 is provided at a first end 136 of the second sealing member 126, and extends therefrom. More particularly, the male portion 134 extends by a first distance “D” along a first longitudinal direction “X₁” towards a male end 138. The male portion 134 disclosed herein includes a gradually increasing width, such that the width “W₁” at the first end 136 of the second sealing member 126 may be minimal Further, the width of the male portion 134 gradually increases along the first longitudinal direction “X₁”. Accordingly, the width “W₂” of the male portion 134 at the male end 138 may be maximal.

The first joint 130 may also include a female portion 140. The female portion 140 is provided at an end 142 of the first sealing member 124, and extends therefrom. The female portion 140 includes a pocket 144 formed therein. The pocket 144 extends by a second distance “d” in a second longitudinal direction “x₁” to a female end 146. The pocket 144 of the female portion 140 may receive the male portion 134 therein. Also, the end 142 of the first sealing member 124 may include an opening 148 provided therein. The pocket 144 of the female portion 140 disclosed herein may have a tapered configuration. More particularly, a width of the pocket 144 may increase gradually along the second longitudinal direction “x₁”, such that a width “w₁” of the opening 148 at the end 142 may be minimal, whereas, a width “w₂” of the pocket 144 at the female end 146 may be maximal.

As shown in the accompanying figures, the width “w₁” of the opening 148 of the female portion 140 may be less than the width “W₂” of the male portion 134 and may be equal or close to equal to the width “W₁” of the male portion 134, such that the first joint 130 may be embodied as a dovetail joint. Therefore, during an assembly of the first joint 130, the male portion 134 is laterally introduced within the pocket 144 of the female portion 140. This design of the male and female portions 134, 140 may lessen, control or prevent a longitudinal disengagement of the male portion 134 from the female portion 140 along the first or second longitudinal direction “X₁”, “x₁”.

As illustrated in the accompanying figures, the second distance “d” of the female portion 140 may be greater as compared to the first distance “D” of the male portion 134. The difference between the first and second distances “D”, “d” defines a volume 150 between the male and female ends 138, 146 of the first joint 130. Referring to FIG. 4, the volume 150 is configured to receive a sealant 152 therein. The sealant 152 may be configured to seal an interface between the first and second sealing members 124, 126.

It should be noted that the first and second distances “D”, “d” may be decided such that the volume 150 holds an optimum amount of the sealant 152 therewithin. The first and second distances “D”, “d” may therefore vary based on applications, sealant properties and required sealant volume. Further, the sealant 152 provided within the volume 150 may be selected from a wide range of available sealants, having properties such as corrosion resistance, adhesion, and/or insolubility with a fluid that may come in contact the sealant 152. In the illustrated embodiment, the sealant 152 is a curable sealant. The sealant 152 may be in a viscous or liquid state. On curing, the sealant 152 is configured to seal the first and second sealing members 124, 126. In one example, the sealant 152 may be a Room Temperature Vulcanization (RTV) silicone. Further, the sealant 152 may be introduced within the volume 150 either manually or by using automated means. In one example, an injection apparatus (not shown) may be used to provide the sealant 152 within the volume 150.

Referring to FIG. 3, the sealing system 118 also includes the second joint 132. As disclosed above, the second joint 132 is configured to couple the second and third sealing members 126, 128 with each other. The second joint 132 includes the male portion 154 provided on a second end 156 of the second sealing member 126. Further, an end 158 of the third sealing member 128 includes the female portion 160. The design and structure of the male and female portions 154, 160 are similar to that of the male and female portions 134, 140 of the first joint 130 explained above. Further, the second joint 132 may also include the volume 162 formed between the male and female portions 154, 160. The volume 162 is configured to receive the sealant 152 therein (See FIG. 4).

It should be noted that the provision of the male portions 134, 154 and the female portions 140, 160 on each of the first, second, and third sealing members 124, 126, 128 disclosed herein is purely exemplary and does not limit the scope of the present disclosure. In an alternate embodiment, instead of providing the two male portions 134, 154 at the first and second ends 136, 156 of the second sealing member 126, the second sealing member 126 may include two female portions. Alternatively, the second sealing member 126 may include one male portion and one female portion provided at either ends 136, 156 of the second sealing member 126.

### INDUSTRIAL APPLICABILITY

Machines typically include various types of assemblies having two or more mating components which require a sealed interface between them in order to prevent fluid leakage therefrom. Gaskets are generally used as a mechanical seal to fill a gap present between the mating components, in order to prevent leakage from or into the mating components while under compression. In some examples, the gaskets include a plurality of pieces that are assembled together to form the gasket. A sealant may be provided to seal the interface between mating surfaces of the mating components.

The present disclosure relates to the sealing system 118. The sealing system 118 includes the plurality of sealing members. The adjacent sealing members of the plurality of the sealing members may be coupled to each other by the joint. The sealing system 118 includes the male portions 134, 154 and the female portions 140, 160. Further, the first and second distances “D”, “d” based on the geometry of the male portions 134, 154 and the female portions 140, 160 respectively, may be so designed that an optimum amount of the sealant 152 may be received within the volume 150, 162 defined therebetween. The volume 150, 162 may provide a definite space for receiving the sealant 152 therein. It is therefore possible to control an amount of the sealant 152 that may be provided to seal the adjacent sealing members of the sealing system 118. Further, based on a consistency in the geometry of the defined volume 150, 162, the amount of the sealant 152 provided in multiple similarly shaped joints may be same or close to same. On curing, the sealant 152 may provide a leak-resistant or leak-proof interface between the adjacent sealing members of the sealing system 118.

Further, the first and second joints 130, 132 are embodied as the dovetail joint. The dovetail design of the first and second joints 130, 132 may provide an interlocking arrangement which may control, minimize or prevent the longitudinal engagement and/or disengagement of the male portions 134, 154 and the female portions 140, 160. This may reduce the possibility of the adjacent sealing members from sliding apart form each other during engine operation. The sealant 152 and the joints 130, 132 together may provide a secure connection between the adjacent sealing members of the sealing system 118.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A sealing system for an interface between two components, the sealing system comprising:
a plurality of sealing members provided adjacent to each other, at least two adjacent sealing members of the plurality of sealing members being coupled to one another by a joint, the joint comprising:
a male portion disposed at an end of one sealing member of the two adjacent sealing members, the male portion extending by a first distance along a first longitudinal direction to a male end; and
a female portion disposed at an end of another sealing member of the two adjacent sealing members, the female portion defining a pocket extending by a second distance along a second longitudinal direction to a female end and configured for receiving the male portion, wherein the second distance is greater than the first distance thereby forming a volume between the male end and the female end, wherein an opening of the female portion has a width less than a maximum width of the male portion in order to prevent disengagement of the male portion from the female portion along the first longitudinal direction or the second longitudinal direction; and wherein the volume is configured to receive a curable sealant therein.
